(19) United States
(12) Patent Application Publication
(10) Pub. No.: US 2014/0338260 A1
(43) Pub. Date: Nov. 20, 2014

(54) Support for Vine Plants and Tomato Plants

(71) Applicant: Aurel Simion Selezeanu, Durham, NC (US)

(72) Inventor: Aurel Simion Selezeanu, Durham, NC (US)

(21) Appl. No.: 13/895,864

(22) Filed: May 16, 2013

(51) Int. Cl. A01G 9/12

(52) U.S. Cl. CPC A01G 9/12
USPC 47/44

(57) ABSTRACT

Purpose of Invention.

The invention is a simple support for vine and tomato plants. It comprises a central support that could be wood, plastic, or bamboo with holes to accept the universal hook. The hook is self supporting on the pole.

Description of Problem(s) Solved by Invention.

The post/pole and universal hook system is a direct replacement for any cage or cage like support systems. It is very simple and easy to use. All components are reusable and should provide years of service. With the use of wooden or bamboo poles the support system is a “greener” alternative to a cage system.

How the Invention is an Improvement over Existing Technology.

There are several types of cages or vine plant supports, but the majority of them are not adjustable or applicable to a variety of plants. For a cage system, harvesting of vegetables is sometimes difficult.

The new system will provide flexibility for plant growth, it will be easy to use and by using wooden or bamboo stakes it will be a greener solution to a full steel or plastic cage.

### BRIEF DESCRIPTION OF FIGURES

The Applicant has attached the following figures of the invention at the end of this provisional patent application:

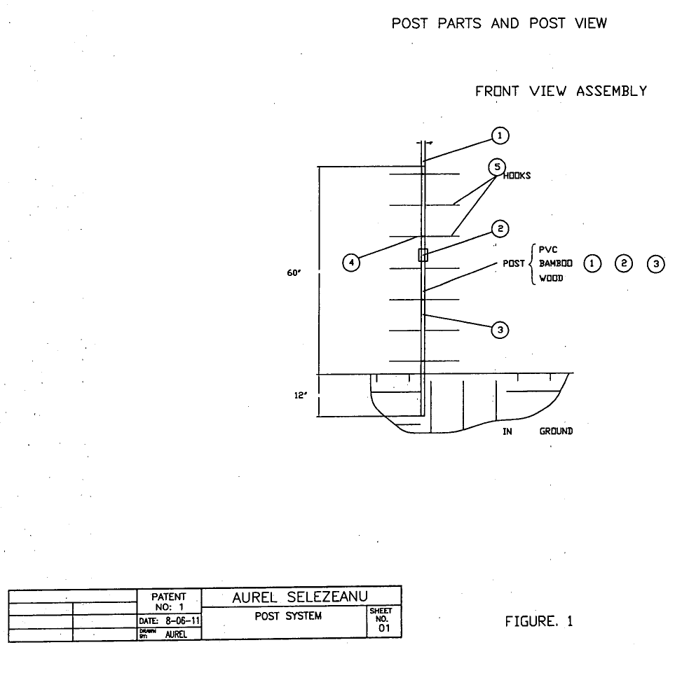

1. Description of FIG. 1: FIG. 1 shows the plant support assembly. The hooks (5) are inserted into the post (3) using the pre-drilled holes (4). For easier installation a coupling could be used to divide the post into two sections (1) and (3). The bottom of the post, approximately 12″ should be secured in the ground for proper support (7).

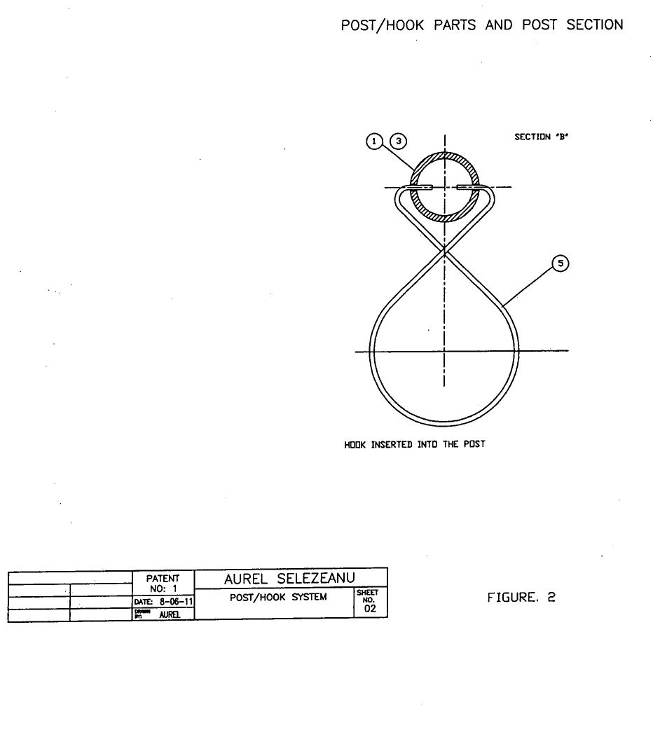

2. Description of FIG. 2: FIG. 2 shows the plant support post/hook section. The hooks (5) are inserted into the post (1, 2, and 3) using the pre-drilled holes (4). FIG. 2 shows the plant support hook inserted into the post. The hooks (5) are made of steel (0.08″ in diameter). The ends of the hooks are a semicircle with a ⅝″ diameter. The hook's (5) side “A” is inserted into the pre-drilled post's hole (4). The hook's side “B” is pushed passed the post (1), and inserted into the opposite side of the same hole (4). The hook self-support in horizontal position and is able to handle 10 or more pounds of load without releasing the post.

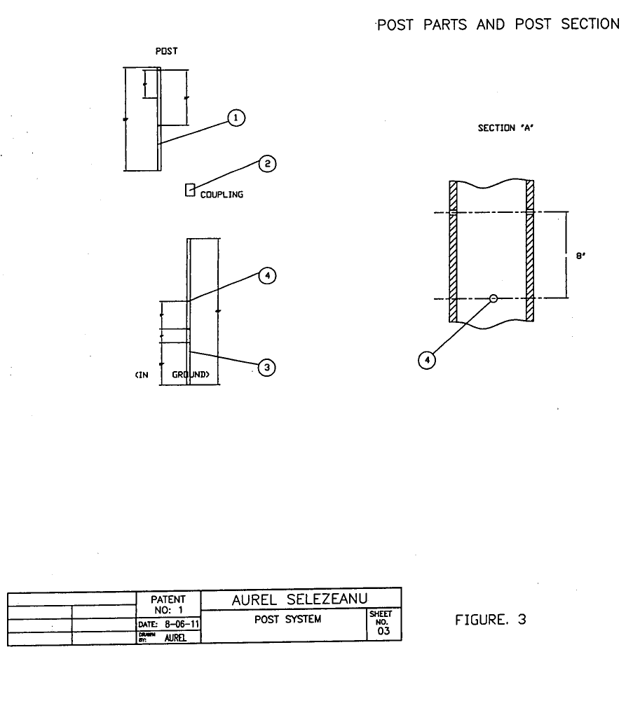

3. Description of FIG. 3: FIG. 3 shows a section of the plant support post. The hook (5) is inserted into the post using the pre-drilled holes (4). The holes are at 8″ apart.

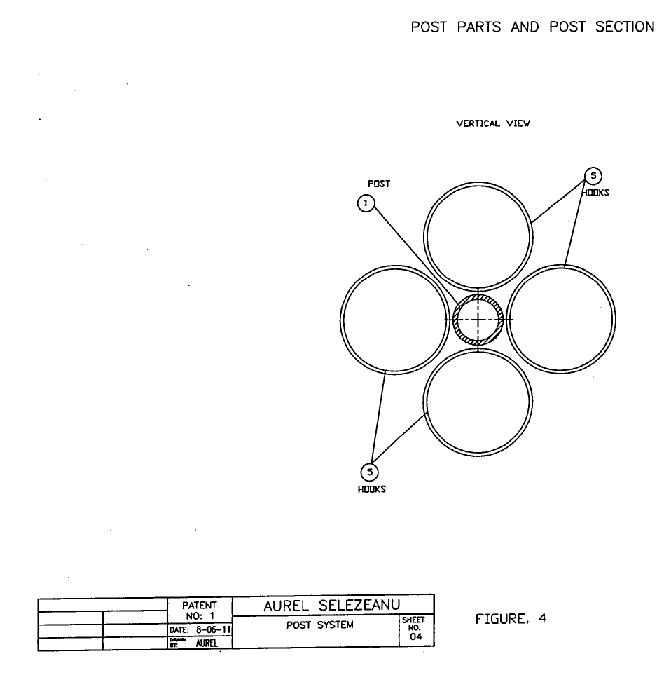

4. Description of FIG. 4: FIG. 4 shows the plant support top view. The hooks (5) are inserted into the post (1, and 3) using the pre-drilled holes (4). For easier installation a coupling (2), could be used to divide the post into two sections (1) and (3). The bottom of the post, approximately 12″ should be secured in the ground for proper support (7).

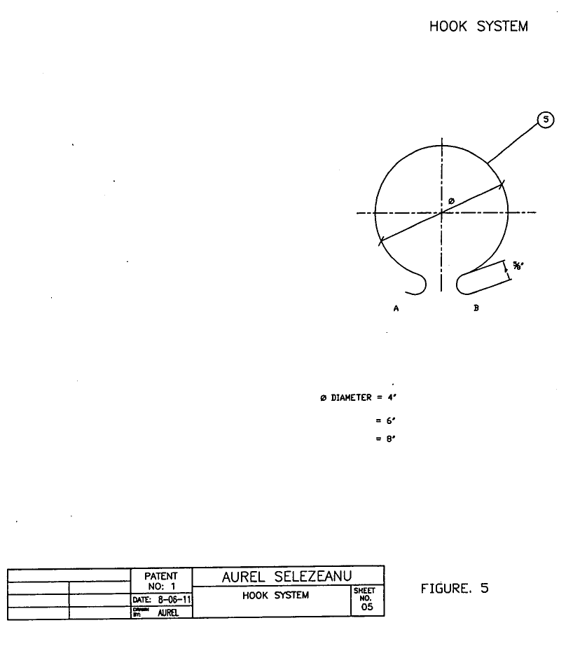

5. Description of FIG. 5: FIG. 5 shows the plant support hook. The hooks (5) are made of steel (0.08″ in diameter). The ends of the hook are a semicircle with a ⅝″ diameter. The hooks are of several diameters from 3″ to 12″.

### REFERENCE NUMERAL NAME OF PART

1 Upper Part of the Pole or Post
2 Coupling
3 Lower Part of the Pole or Post
4 Pole or Post holes
5 Hook of several diameters

### DETAILED DESCRIPTION OF INVENTION

Description of the Parts of the Invention.

This is a direct replacement of the traditional cage for vine plants as tomatoes. A simple combination of post/pole (1, 2, and 3) and hooks (5) creates a robust support for the plant that is easy to use, flexible and reusable year after year.

The post (1,2, and 3) could be PVC, bamboo or wood with a minimum of 1″ in diameter or in the case of wood 1″ square. There are pre-drilled holes (4) with a 9/64 drill bid. These holes are 8 to 10 inch apart.

The most part of the support is the hook (5). The hook has a special design that make possible to self-support once connected to the post.

Relationship Between the Parts of the Invention.

As presented in the sectional drawing, the hook (5) is inserted in one of the pre-drilled holes (4) and is crossed over and inserted in the opposite hole (180 degrees). Once secured in place, the assembly post/hook will offer a strong plant support.

Description of How the Invention Operates/Functions.

The post/pole (1, 2, and 3) should be driven into the ground for approximately one foot. The hooks (5) should be added to the post as needed to maintain plant support.

Unique Features of Invention.

The originality is in the way the hook (5) support itself to the post (1, 2, and 3) and the rigidity of the assembly. This system uses less steel than a traditional “cage”; it has more flexibility and could be used for a large number of vine plants.

How to Make the Invention.

There are several ways to make this post/hook support. For large quantities wire manufacturers could produce the hook at a small price depending on quantity.

The post is available on the market (PVC, bamboo or wood).

Alternative Embodiments of Invention.

The hook could have several other applications as support for plant or other devices. The hook could be used for cable trays or other supporting means.

### DRAWINGS OF INVENTION

Attached to the end of this U.S. Provisional Patent Application are the drawings of the invention.

1. The present invention general purpose is to provide a new plant support that is well anchored on the ground, sturdy and sufficient to support even large tomato fruits grown on supported plants. The hooks of different sizes help support the plant at different stages and keep the area clear for watering and mulching the plant's root.

2. To accomplish these objectives, the plant support comprises a pole that could be of PVC, Wood or Bamboo. The pole has predrilled holes at eight to twelve inch interval, and alternating at 90 degrees. The support also comprises of several posts insertable hooks of a special design that will provide a self supporting horizontal position. In general the system is designed for plants that are 5-6 ft tall, but with an additional coupling and extension could be extended up to 8 ft.

3. The most important feature of the invention is the hook and the modality to connect the hook to the post. The more detailed description that follows may be better understood and should present the new contribution to the plant support system. Additional features of the invention will be described hereinafter and will form the subject matter of the claims that follow.

4. The assemble post/hook is a new concept to support vine plants
